(19) United States
(12) Patent Application Publication
(10) Pub. No.: US 2020/0109030 A1
(43) Pub. Date: Apr. 9, 2020

(54) ELEVATOR BEING MONITORED WITH PASSENGER SMART MOBILE DEVICE

(71) Applicant: Inventio AG, Hergiswil (CH)

(72) Inventors: Zack Zhu, Baar (CH); Martin Kusserow, Luzern (CH); Andrew Paice, Dättwil (CH); Heinz Widmer, Rotkreuz (CH); Raphael Zimmermann, Luzern (CH)

(21) Appl. No.: 16/610,552

(22) PCT Filed: Jun. 19, 2018
(86) PCT No.: PCT/EP2018/066171

§ 371 Date: Nov. 4, 2019

(30) Foreign Application Priority Data
Jun. 27, 2017 (EP) 17178183.4

(51) Int. Cl. B66B 5/00; B66B 1/34

(52) U.S. Cl. CPC B66B 5/0025; B66B 5/0031; B66B 1/3461; B66B 5/0087; B66B 5/0037

(57) ABSTRACT

A holder structure fixed to an elevator car of an elevator is configured to hold a passenger's smart mobile device. The mobile device includes sensors, and the holder structure releasably mechanically couples the mobile device to the elevator car. A method for monitoring an operation of the elevator includes providing the mobile device with a specific application software controlling the mobile device to execute the following monitoring procedure: repeatedly supervising measurement values of at least one of the sensors; upon occurrence of a specific parameter pattern in the measurement values, starting a measurement acquisition procedure during which measurement values are sensed by at least one of the sensors and the sensed measurement values are transmitted to an evaluation unit for further evaluation. The specific parameter pattern specifically results upon the mobile device being held in at least one of a predefined position and a predefined orientation in the elevator car.

### FIELD

The present invention relates to an elevator and to a method for monitoring an elevator operation.

### BACKGROUND

Elevators generally comprise an elevator car, sometimes also referred to as a cabin, which may be displaced along a travel path which, in most cases, is included in an elevator shaft extending vertically throughout a building.

In order to guarantee safe and efficient operation of the elevator, the operation of the elevator should be continuously or repeatedly monitored in order to detect any malfunctions or failures which may then be e.g. repaired during maintenance service. Various approaches for monitoring the operation of the elevator have been developed.

For example, US 2016/0130114 A1 discloses a method for monitoring an elevator in which a passenger with a mobile device such as a mobile phone or smartphone may conduct measurements within the elevator car and transmit measurement results to a central evaluation unit. The mobile device comprises a microphone for detecting noises during elevator travel. The passenger starts a program on the mobile device, thereby starting the measurements and data transmission. For example, the passenger conducting the measurements may be a service technician or any other user of the elevator.

Another approach is described in EP 16 188 445 (see WO 2018/050470 A1). Therein, a mobile device is automatically activated for sensing measurement data relating to the operation of an elevator and transmitting the measurement data to an evaluation unit upon recognizing that the mobile device is located within an area of an elevator shaft door. This approach has been described by the applicant of the present invention and the content of EP 16 188 445 shall be incorporated herein by reference as some of the ideas and details of this prior approach may be applied or transferred to the new approach described herein.

CN 203048372 U describes an elevator car with a mobile phone charging unit.

JP 2015168560 A describes a vibration noise measurement unit of an elevator with a mobile phone. The mobile phone comprises a vibration sensor and a microphone. The mobile phone is attached to a tripod during the measurement.

US 2017/0029244 A1 describes an elevator performance analysis device comprising a sensor package and a computing device. The sensor package is arranged at an elevator car.

US 2015/0284214 A1 describes a mobile device with sensors for generating scores relating to as elevator car's performance. The mobile device can communicate with a peripheral sensor placed within the elevator car.

### SUMMARY

There may be a need for further improving monitoring capabilities in an elevator. Particularly, there may be a need for an elevator and a method for monitoring an operation of the elevator in which monitored parameters may be acquired in a reliable manner, automatically and/or at a high repetition rate.

According to a first aspect of the present invention, an elevator comprising a displaceable elevator car is proposed, wherein a holder structure is fixed to the elevator car and is configured to hold a passenger's smart mobile device, the mobile device including at least one sensor, and the holder structure being specifically configured to mechanically couple the mobile device to the elevator car in a releasable manner. The holder structure is configured for holding the mobile device such that acceleration sensors of the mobile device sense an acceleration pattern which specifically results upon the mobile device being held by the holding structure and/or the holder structure is configured for holding the mobile device such that a light sensor of the mobile device senses a light pattern which specifically results upon the mobile device being held by the holding structure.

According to a second aspect of the present invention, a method for monitoring an operation of an elevator is proposed. The method comprises providing a passenger's smart mobile device including a plurality of sensors with a specific application software, the application software controlling the smart mobile device to execute the following monitoring procedure: (i) repeatedly supervising measurement values of at least one of the sensors of the mobile device; (ii) upon occurring of a specific parameter pattern in the measurement values, starting of a measurement acquisition procedure during which measurement values are sensed by at least one of the sensors and the sensed measurement values are transmitted to an evaluation unit for further evaluation. Therein, the specific parameter pattern specifically results upon the mobile device being held in a predefined position and/or a predefined orientation in the elevator car. For example, the predefined position and/or predefined orientation may be established upon the mobile device being held by a holder structure configured to mechanically couple the mobile device to the elevator car.

According to a third aspect of the present invention, a computer program product comprising computer readable instructions is proposed, wherein the computer readable instructions, when performed by a processor of a smart mobile device, instruct the mobile device to execute or control the smart mobile device to execute the monitoring procedure as defined in accordance with an embodiment of the above second aspect of the invention.

According to a fourth aspect of the invention, a computer readable medium comprising a computer program product in accordance with an embodiment of the above third aspect of the invention stored thereon is proposed.

Ideas underlying embodiments of the present invention may be interpreted as being based, inter alia and without restricting a scope of the invention, on the following observations and recognitions:

For effectively monitoring an elevator and its operation, it may be important to acquire measurement data relating to current conditions in the elevator. Formally, a variety of multiple sensors had been included and distributed throughout the elevator for sensing local elevator conditions such as forces or accelerations acting onto elevator components, noises occurring at elevator components, electric, magnetic or electromagnetic fields occurring at or close to elevator components, etc. However, such conventional approach required not only manufacturing the sensors but also installing and potentially wiring the sensors in the elevator, thereby adding substantial costs.

In the novel approaches mentioned in the above introductory portion, it is proposed to use mobile devices which themselves already comprise a multiplicity of sensors in order to acquire measurement data relating to current elevator conditions. For example, such mobile device may be a mobile phone, a smart phone, a tablet computer, a smartwatch, a so-called wearable for example in the form of an electronic smart textile or any other portable terminal device. Such mobile device may comprise various sensors such as a microphone, an acceleration sensor, a rotation rate sensor, a magnetic field sensor, a camera, a pressure sensor, a light sensor, a humidity sensor, a gas sensor, etc. particularly, acceleration sensors, rotation rate sensors and magnetic field sensors may be embodied as three-dimensional or 3D sensors which may provide measurement values in three directions orthogonal to each other. Particularly, the mobile device may comprise different types of sensors. Furthermore, the mobile device may comprise a processor for processing data received from the sensors. Additionally, the mobile device may comprise a data transmission unit for transmitting data to external devices via wireless data communication and/or wired data communication. Due to its capability of measuring and, optionally, processing physical parameters, such mobile devices are also referred as “smart” mobile devices.

As, today, many people carry personal smart mobile devices with them, it was an idea to use these smart mobile devices and their sensors for monitoring operation parameters of an elevator. For example, it was suggested to use the microphone of a mobile device for “listening” to any non-normal noises during elevator travel. Furthermore, it was proposed in the applicant's prior approach described in EP 16 188 445 to specifically configure the mobile device such that a data acquisition including measurements is automatically triggered upon the mobile device realizing that it is close to a shaft door of an elevator.

However, it has been observed that the measurement data acquired by the smart mobile devices of passengers during elevator travel do not always provide sufficient or reliable information about the operation status and/or about any malfunctions in the elevator. Particularly, it has been found that for example accelerations acting in the elevator and its elevator car are not measured by the smart mobile device with a sufficient accuracy and/or reliability.

It is assumed that one reason for this observation is that passengers usually carry their mobile devices either in their hands or in a pocket or a purse. Accordingly, for example motions of the elevator car are significantly damped before reaching the mobile device such that these motions or corresponding accelerations may hardly be precisely measured with the sensors comprised in the mobile device.

It is therefore proposed herein to provide an elevator car with a specific holder structure. This holder structure is fixed to the elevator car such that any motions and accelerations of the elevator car are transferred to the holder structure, preferably with no or only a negligible damping. The holder structure is specifically configured to hold a passenger's smart mobile device. Specifically, the holder structure is configured for mechanically coupling the mobile device to the elevator car in a releasable manner.

Accordingly, upon using the elevator car, a passenger may use the holder structure for mechanically coupling his own smart mobile device with the elevator car such that forces and accelerations acting in the elevator car are directly transmitted to the mobile device with no or negligible damping. Accordingly, the sensors, particularly the motion sensors, acceleration sensors, rotation rate sensors, etc., may precisely measure any physical parameters relating to or resulting from motions of the elevator car.

According to an embodiment, the holder structure is configured for holding the mobile device in a positive fit connection.

The positive fit connection is sometimes also referred to as form closure connection. Generally, a positive fit connection is established upon two components engaging with each other due to their structural form or geometry. Thereby, in contrast to a frictional connection, the partnering components may not be released from each other in the direction in which the positive fit connection is established even in situations where there is no force transmission or a force transmission is interrupted. Upon operational loads, pressure forces generally apply, i.e. forces being orthogonal to the contacting surfaces of the partnering components. Such “blocking” applies in at least one direction, however, in case there is more than one contact between surfaces of both partnering components, blocking may apply in multiple directions.

As applied to the holder structure proposed herein, this may mean that the holder structure is specifically adapted with respect to its geometry such as to hold and/or accommodate a smart mobile device such that, upon being coupled with the holder structure, the smart mobile device may no more be moved at least in one direction in which the positive fit connection is established.

For example, the holder structure may have a lower surface, or bottom surface, onto which the mobile device may be placed. Upon placing the mobile phone on such lower surface, it is coupled to the holder structure by a positive fit connection acting in the gravity direction, i.e. it may not be displaced further in a direction orthogonal to the lower surface, i.e. for example in a downward direction. In other words, upon being coupled with the holder structure, the mobile device is restricted by the lower surface in one degree of its freedom of motion.

Preferably, the holder structure may not only have one surface for contacting the mobile device for establishing the positive fit connection, but comprises two or more surfaces extending in directions transverse to each other. For example, additional to the lower surface, which preferably may be horizontal, the holder structure may have side surfaces extending transverse to the lower surface. Such side surfaces may restrict a further degree of motion of the mobile device upon being coupled to the holder structure.

Optionally, several such side surfaces may be provided on the holder structure, the side surface being transverse to each other, such as to generate a geometry of the holder structure in which the mobile device is restricted in three or more degrees of freedom of motion.

For example, the geometry of the holder structure may be specifically adapted such that a mobile device may be easily “put into” the holder structure from above and is then held by the lower surface and one or more side surfaces of the holder structure until released from such positive fit connection by taking the mobile device out of the holder structure in an upward direction. Accordingly, the mobile device may be easily mechanically coupled to the holder structure and easily released from the holder structure at a later point in time.

According to an embodiment, the holder structure is configured for holding the mobile device such that the at least one sensor of the mobile device senses a parameter pattern which specifically results upon the mobile device being held by the holding structure.

In other words, the holder structure may be configured to not only mechanically hold the mobile device in any arbitrary configuration but, instead, it may be configured to hold the mobile device in a specific configuration in which the at least one sensor of the mobile device necessarily senses a specific value or a specific sequence of values of the parameter sensed by this sensor, such value or sequence of value being referred to as parameter pattern.

Accordingly, the mobile device may be specifically configured to being triggered to monitoring the operation of the elevator automatically. Specifically, the mobile device may continuously or repeatedly measure parameters with its sensors and may then determine whether or not the measured parameters correspond to the predetermined parameter pattern. If this is the case, this may be taken as indicating that the mobile device is currently mechanically coupled with the holder structure in the elevator car. Upon having recognized this, the mobile device may be automatically triggered to start a measurement acquisition procedure in which it acquires measurement values using its sensors. Therein, the mobile device may use the same sensor which had been used to determine that the predetermined parameter pattern has occurred or, alternatively or additionally, other sensors of the mobile device may be used to measure other parameters.

Preferably, the geometry or other physical features of the holder structure are made such that the sensors of the mobile device, when being coupled to the holder structure, sense specific values which rarely occur in other situations of use of the mobile device or which are even unique. Particularly, the holder structure may be configured such that, upon the mobile device being coupled with the holder structure, at least one of the sensors in the mobile device senses a parameter value which rarely occurs as long as the mobile device is not coupled to the holder structure.

Optionally, a multiplicity of parameter values may be monitored for the occurrence of a specific parameter pattern, i.e. it may be monitored whether each of a plurality of sensors senses predetermined parameter values. If such parameter pattern including a multiplicity of predetermined parameter values occurring simultaneously is detected, this may be interpreted as reliably indicating that the mobile device is currently coupled with the holder structure.

For example, in accordance with an embodiment, the holder structure may be configured for holding the mobile device such that acceleration sensors of the mobile device sense an acceleration pattern which specifically results upon the mobile device being held by the holding structure.

In other words, the holder structure may have a geometry or other physical features such that, when coupled with the mobile device, it holds the mobile device in a specific orientation. As smart mobile devices typically comprise 3D acceleration sensors, the current orientation of the mobile device may be determined due to the gravity acceleration. This means, using the 3D acceleration sensors, an actual current orientation of the mobile device with respect to the gravity direction may be determined.

For example, if the orientation in which the holder structure holds and fixes the mobile device is an orientation which rarely occurs during other modes of use of the mobile device, detecting that the mobile device is currently in this specific orientation may be taken as indicating that it is coupled with the holder structure.

Accordingly, in accordance with an embodiment of the proposed monitoring method, the monitoring procedure may comprise continuously supervising acceleration measurement values of acceleration sensors of the mobile device and, upon occurring of a specific acceleration pattern in the acceleration measurement values, the measurement acquisition procedure may be started.

In other words, when a passenger's mobile device has been coupled with the holder structure in the elevator car, this may be automatically detected due to a comparison of the actual acceleration measurement values with those of the predetermined specific acceleration pattern. If the actual acceleration measurement values are identical or at least correspond within acceptable tolerances with the predetermined specific acceleration pattern, this may indicate that the mobile device is coupled with the holder structure. In case it is detected that the mobile device is coupled with the holder structure, the mobile device may start using its sensors for sensing physical elevator conditions in its neighborhood such as sensing accelerations, sensing noises, sensing magnetic or other physical fields, sensing illumination, etc.

According to a specific embodiment, the holder structure may be configured for holding the mobile device in a predefined inclined orientation.

In other words, the holder structure may be configured with respect to its geometry and/or other physical characteristics such that the mobile device may be coupled with the holder structure only if it is arranged in the predefined inclined orientation. For example, contacting surfaces formed e.g. by a bottom and one or more side walls of the support structure may be arranged such that the mobile device is mechanically supported in its predefined inclined orientation. In such predefined inclined orientation, the mobile device typically having a quasi-two-dimensional structure, extends in a plane which is neither horizontal nor vertical but somewhere in between these two extremes. For example, the predefined inclined orientation may include a specific angle with respect to the horizontal and/or a vertical plane. Such specific angle may be for example between 1° and 89°, preferably between 5° and 85° and more preferably between 10° and 60° and even more preferably between 40° and 50°. Particularly, a mobile device having a generally rectangular geometry may be held in a predefined inclined orientation in which a specific angle is included with respect to both the horizontal and any vertical plane. For example, when arranged at a predefined orientation of approximately 45° to the horizontal, the mobile device is in an uncommon orientation which is most distant from both 0° (corresponding e.g. to the mobile device lying on a horizontal surface) as well as 90° (corresponding e.g. to the mobile device sitting upright in a pocket).

According to an embodiment, the holder structure may be configured for holding the mobile device such that a light sensor of the mobile device senses a light pattern which specifically results upon the mobile device being held by the holding structure.

In other words, instead or additionally to holding the mobile device in a specific orientation, the holder structure may be adapted such that, when coupled with the holder device, a light sensor of the mobile device senses a specific light pattern. Such light pattern may result from the physical features of the holder structure alone or in combination with physical features of its environment.

For example, the holder structure may be made such that a light receiving surface of the light sensor is completely blocked, i.e. a light intensity sensed by the light sensor is 0. Alternatively, the holder structure may comprise a light filter such that light reaching the light sensor of the mobile device coupled to the holder structure comprises a specific spectrum. As a further alternative, the holder structure may be configured such that, upon being coupled with the holder structure, the light sensor of the mobile device is directed in a specific manner such as to receive light for example from environmental components, this light having a predefined characteristic. For example, the mobile device with its light sensor may be directed towards a ceiling of the elevator car, this ceiling comprising light emitters such as lamps, LEDs, etc. emitting light with a specific spectrum and/or other light characteristics. Or the mobile device may be directed with its light sensor towards a surface within the elevator car, the surface having a specific color and/or a specific design or graphical pattern to be optically recognized by the light sensor.

In accordance with an embodiment of the monitoring method, the mobile device may then continuously supervise light measurement values of the light sensor and, upon occurring of a specific light pattern in the light measurement values, the mobile device may start the measurement acquisition procedure in which it acquires measurement values with its sensors and transmits these measurement values towards an evaluation unit.

In other words, the mobile device may continuously monitor whether its light sensor senses a specific light pattern, this light pattern being characteristic for example due to its light spectrum, light intensity, geometrical arrangement, time profile, or other optically detectable characteristics. If the actually sensed light is identical or at least sufficiently corresponds within tolerances to the predefined specific light pattern, this may be taken as indicating that the mobile device is currently coupled with the holder structure in the elevator car.

Of course, specific parameter patterns may comprise a multiplicity of various physical parameters to be sensed by the various sensors comprised in the mobile device. For example, measuring both, a 3D acceleration pattern as well as a light pattern, and comparing them to a combination of a predefined specific 3D acceleration pattern and a predefined specific light pattern, respectively, in order to automatically detect that the mobile device is coupled to the holder structure may significantly increase a reliability of such automatic detection.

In accordance with a specific embodiment of the monitoring method, the mobile device may continuously supervise the measurement values and, upon occurring of the specific parameter pattern in the measurement values for more than a predetermined time interval, it may start the measurement acquisition procedure.

In other words, the measurement values may not only be compared to a specific parameter pattern at one point in time. Instead, such comparison is made during the entire predetermined time interval, i.e. within the predetermined time interval it is continuously or repeatedly checked whether the currently sensed measurement values correspond to the predefined parameter pattern, optionally within acceptable tolerances. If this is the case, then the measurement acquisition procedure is started and acquired measurement values are transmitted to the evaluation unit.

For example, the predetermined time interval may be in a range of between several milliseconds and several seconds, specifically, the predetermined time interval may be longer than 100 ms, longer than one second or longer than five seconds.

Therein, the specific parameter pattern may be static, i.e. it may be compared whether the sensed measurement values sufficiently corresponds to a single specific parameter pattern value during the entire predetermined time interval. For example, it may be observed whether the orientation of the mobile device, which may be detected based on the sensed acceleration pattern as measured based on signals from the 3D acceleration sensor, corresponds to an intended orientation in which the mobile device is held in the holder structure, and it is furthermore checked whether this orientation is stable over the predetermined time interval. Similarly, it may be observed whether acquired light measurement values correspond to the predetermined specific light pattern over the predetermined time interval.

Alternatively, the specific parameter pattern may be time-dependent, i.e. dynamic. In that case, it may be checked whether the sensed measurement values correspond to the dynamic specific parameter pattern during the entire predetermined time interval. For example, when held in the holder structure in a specific orientation, the 3D acceleration measurement values will mainly depend on gravity as long as the elevator car is stopped but will then change in a specific manner as soon as the elevator car is accelerated, such acceleration being typical for a specific type of elevator. Accordingly, upon supervising the measurement values for a time interval covering, inter-alia, an acceleration phase of the elevator car, a time-dependent profile of the measurement values may be compared to a predetermined parameter pattern profile. Based on such comparison, it may be detected with high accuracy and reliability not only that the mobile device is in a specific orientation but also that it is accelerated along the travel path of the elevator car with a specific time profile resulting from the specific acceleration profile of the elevator car. Accordingly, a risk of any “false-positives” in detecting that the mobile device is held in the holder structure may be minimized.

According to an embodiment, the holder structure is fixedly attached either to an elevator car wall or to an elevator car carrier structure.

In other words, the holder structure may be fixed to a wall of the elevator car, such wall typically limiting an interior space of the elevator car and being directly accessible by any passenger. Therein, the elevator car wall is generally fixedly connected to other load carrying structures of the elevator car and may therefore transmit any forces, vibrations or accelerations acting at or onto such load carrying structures.

Alternatively, the holder structure may be directly attached to the elevator car carrier structure, i.e. to the main load carrying structure which is sometimes referred to as car sling which encloses the elevator car walls. In such configuration, any forces, vibrations or accelerations are directly transmitted to the holder structure, i.e. without any potential damping losses for example at intermediate car walls. Preferably, openings are provided in the car wall such that for example a fixing structure of the holder structure may extend through the car wall towards the elevator car carrier structure located there behind.

According to an embodiment, the holder structure is fixedly attached to the elevator car at a position neighboring a door displacement path along which an elevator car door is displaceable upon being opened and closed.

In other words, while, in principle, the holder structure may be fixed in the elevator car at any arbitrary position, it may be beneficial to arrange the holder structure close to the elevator car door, i.e. at or close to an area where the elevator car door is moved along upon being opened or closed. In such configuration, for example any vibrations induced by the moving car door may be transmitted to the holder structure and may then be measured by the smart mobile device's sensors. Thereby, for example any failures or malfunctions in the car door function resulting for example in increased vibrations may be detected. Furthermore, a motion of the car door may be detected using for example a magnetic field sensor which may detect changes in a local magnetic field due to the car door changing its configuration, the car door typically being made from a material which may be magnetized and therefore influences the local magnetic field. For example, the holder structure may be arranged at an elevator car wall directly neighboring an access opening to the elevator car to be opened and closed by the elevator car door.

According to an embodiment, the elevator comprises motivation measures for motivating a passenger to couple his personal smart mobile device with the holder structure during an elevator travel.

Generally, whether or not operation of the elevator may be successfully monitored with the proposed approach mainly depends on whether passengers are willing to provide their personal mobile device for such purpose by coupling it with the holder structure provided in the elevator car. Accordingly, some motivation to do this may be provided to the passengers. Various motivation measures are possible and will be described in more detail further below with respect to specific embodiments. Generally, offering special elevator services such as for example prioritized transport, providing games during transport, badging of time in and out of a building or floor, or other incentives are possible.

Briefly summarizing, it is proposed to provide a specific holder structure within the elevator car such that a passenger may couple his personal smart mobile device statically with the elevator car via the holder structure. A software application, sometimes briefly referred to as “app”, may enable the mobile device to continuously, i.e. steadily or repeatedly, supervising measurement values of at least one of the sensors of the mobile device and compare them with one or more predetermined parameter pattern. Therein, the parameter patterns correspond to measurement values which are obtained when the mobile device is coupled in the holder structure. Thereby, it may be detected when the mobile device is correctly coupled to the holder structure and such detection may automatically trigger the start of the measurement acquisition procedure. During this measurement acquisition procedure, measurement values are sensed by the mobile device's sensors. The measurement values may immediately be transmitted to an evaluation unit. Alternatively, the measurement values may be preliminarily stored and then, at a later point in time, transmitted to the evaluation unit. The evaluation unit may be remote from the elevator car or remote to the entire elevator. For example, the evaluation unit may be located in a remote control center monitoring correct operation of the elevator. Such remote control center may be placed for example at the location of an elevator manufacturer or an elevator maintenance service provider. Accordingly, as each passenger may easily couple his personal terminal device with the elevator car using the holder structure and as, furthermore, there may be some motivation measures for the passenger to do so, large amounts of measurement data may be acquired throughout a large number of elevator car runs. Thereby, operation of the elevator may be monitored frequently and therefore reliably.

It may be noted that the application software to be installed on the mobile device may be the computer program product according to the third aspect of the invention. Particularly, such computer program product may be programmed in any computer language to be interpreted for example by a central processing unit (CPU) of the smart mobile device. Furthermore, the computer program product may be stored on any computer readable medium such as portable computer readable media including a flash memory, a CD, a DVD, etc. or such as stationery computer readable media from which software may be downloaded such as a server or the Internet in general.

It shall be noted that possible features and advantages of embodiments of the invention are described herein partly with respect to an elevator comprising a holder structure in its elevator car and partly with respect to a method for monitoring an operation of an elevator based on the use of passenger's mobile devices coupled to such holder structure. One skilled in the art will recognize that the features may be suitably transferred from one embodiment to another and features may be modified, adapted, combined and/or replaced, etc. in order to come to further embodiments of the invention.

In the following, advantageous embodiments of the invention will be described with reference to the enclosed drawings. However, neither the drawings nor the description shall be interpreted as limiting the invention.

### DESCRIPTION OF THE DRAWINGS

FIG. 1 shows an elevator with an elevator car including a holder structure in accordance with an embodiment of the present invention.

FIG. 2 shows a side view onto a simple holder structure for an elevator according to an embodiment of the present invention.

FIG. 3 shows a front view onto the holder structure of FIG. 2.

FIG. 4 shows a positional arrangement of a holder structure in an elevator car of an elevator according to an embodiment of the present invention.

The figures are only schematic and not to scale. Same reference signs refer to same or similar features.

### DETAILED DESCRIPTION

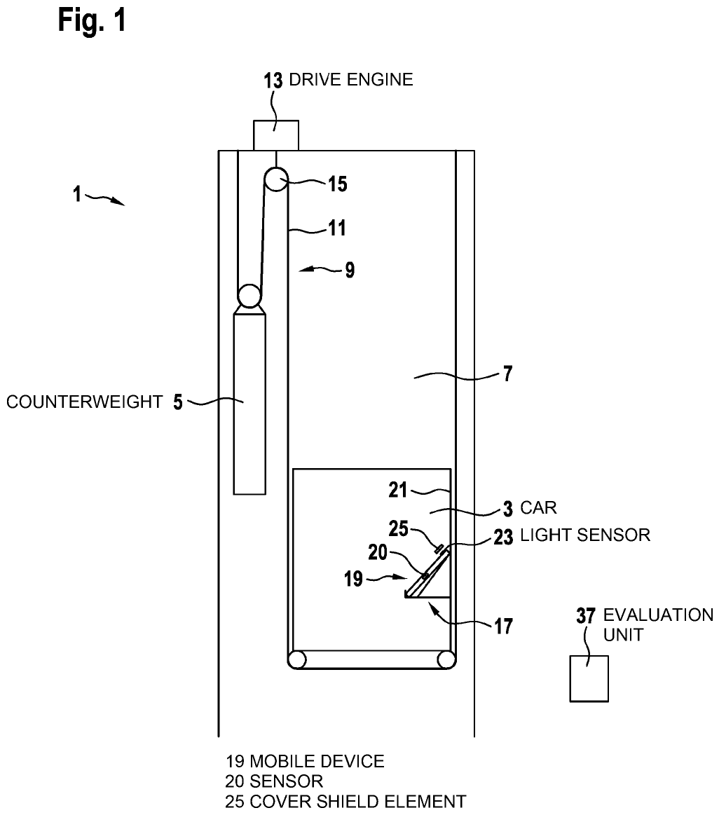

FIG. 1 shows an elevator 1 comprising an elevator car 3 and a counterweight 5. By driving a suspension traction means 9 comprising for example a plurality of belts 11 via a traction sheave 15 of a drive engine 13, the elevator car 3 and the counterweight 5 may be displaced in a vertical direction in an elevator shaft 7.

As a specific feature, a holder structure 17 is fixedly provided within the elevator car 3. This holder structure 17 is configured to hold a passenger's smart mobile device 19 including at least one sensor 20, such as a smartphone, wherein the mobile device 19 may be releasably mechanically coupled via the holder structure 17 to the elevator car 3. In the example shown, the holder structure 17 is fixedly and rigidly attached to a side wall 21 of the elevator car 3.

Specifically, the holder structure 17 may be configured such that the mobile device 19 may be coupled to it in a positive-fit connection in a way such that the mobile device 19 is held in a specifically predefined orientation. Preferably, the predefined orientation is inclined with respect to a vertical plane.

Furthermore, the holder structure 17 may comprise a cover shield element 25 in order to cover a light sensor 23 of the mobile device 19 or to arrange for example a light source or a light filter on top of the light sensor 23. Alternatively, the mobile device 19 may be oriented with its light sensor 23 directed towards a specific light source inside the elevator car 3.

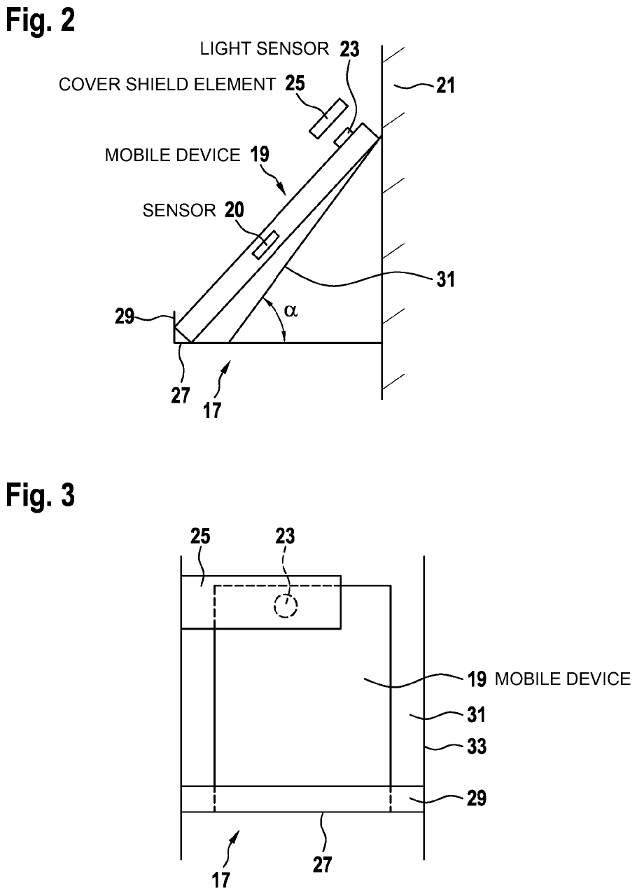

FIG. 2 and FIG. 3 show a side view and a front view onto an exemplary holder structure 17. The holder structure 17 is attached to the elevator car's side wall 21 and comprises a bottom element 27 extending substantially horizontal and a front abutment element 29 extending substantially in a vertical plane. Furthermore, a rear abutment element 31 is provided and extends in an inclined angle α with respect to the horizontal plane. Additionally, a side abutment element 33 may be provided at opposing sides of the holder structure 17.

Accordingly, the holder structure 17 forms with its bottom element 27, front abutment element 29, rear abutment element 31 and side abutment element 33 a receptacle, into which a mobile device 19 may be put from an upside direction and is then held in a positive-fit connection within the receptacle such that, due to gravity and the boundaries formed by the front, rear and side abutment elements 29, 31, 33, the mobile device 19 is fixedly held, i.e. is coupled, to the holder structure 17.

Particularly, the mobile device 19 is held in a predefined inclined orientation with respect to the horizontal plane. Therein, depending on a thickness of the mobile device 19, the mobile device 19 may either lie with its rear surface completely along the rear abutment element 31 such that the mobile device is arranged in the angle α. Or, if the mobile device 19 is thinner than the distance between the lower end of the rear abutment element 31 and the front abutment element 29, the mobile device 19 may slightly slide towards the front abutment element 29 (as shown in the exemplary representation in FIG. 2), such that the mobile device 19 assumes an angle with respect to the horizontal plane which is slightly smaller than the angle α. In fact, the actual angle with which the mobile device 19 will be held within the holder structure 17 may depend on the thickness and the length of the mobile device 19 such that, upon knowing these parameters, the orientation in which the mobile device 19 will be held in the holder structure may be easily determined.

Furthermore, in the shown example, the holder structure 17 comprises the cover shield element 25 which covers the light sensor 23 at the front side of the mobile device 19 such that substantially no ambient light reaches the light sensor 23.

In an alternative embodiment (not shown in the figures), the holder structure 17 could be established similarly to a “selfie stick”, which is mounted in the elevator car 3 in such a way that by mechanical transmission of accelerations and vibrations from the elevator car 3 via the holder structure 17 to for example a passenger's smart phone, the accelerations and vibrations acting at or onto the elevator car 3 may be precisely measured with a high quality and possibly in a standardized manner using the sensors 20 comprised in the smart phone.

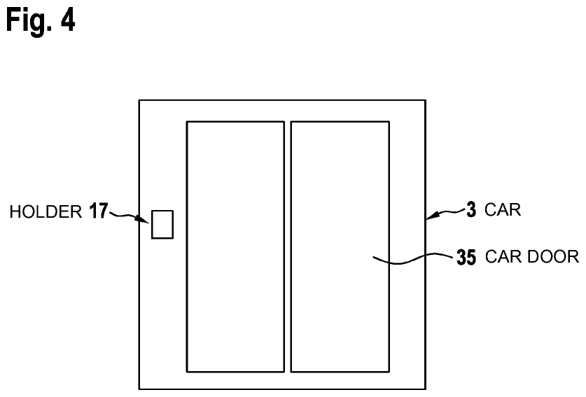

As shown in FIG. 4, the holder structure 17 may be fixed next to an elevator car door 35, i.e. at a position neighboring to a door displacement path along which the elevator car door 35 is displaced upon being opened or closed. Alternatively, a similar holder structure 17 could be constructed and fixed on an exterior of elevator doors 35, for example to activate sensing or other desired processes in the mobile device 19.

In order to enable a use of a passenger's mobile device 19 for monitoring the operation of the elevator 1, an application software, i.e. an “app”, may be installed on the mobile device 19. This application software controls functions of the mobile device 19 such as to execute a specific monitoring procedure. In such monitoring procedure, the mobile device 19 uses at least one of its sensors 20 to repeatedly or continuously measure measurement values and supervise these measurement values. Particularly, it is supervised whether the measurement values correspond to a predetermined specific parameter pattern, possibly within acceptable tolerances.

Therein, the specific parameter pattern corresponds to measurement values which are generally acquired upon the mobile device 19 being held at a specific position within the elevator car 3 and/or in a specific orientation, possibly within acceptable tolerances. For example, such specific position and/or specific orientation may be established upon the mobile device being coupled to the holder structure 17.

Particularly, the parameter pattern may be a specific acceleration pattern which is measured by a 3D acceleration sensor of the mobile device 19 when the mobile device 19 is coupled to the holder structure 17 and is therefore held in the specific inclined orientation. Instead or additionally, the parameter pattern may be or may include a specific light pattern which is measured by a light sensor 23 of the mobile device 19 when the mobile device 19 is coupled to the holder 17 and for example the cover shield element 25 covers the light sensor 23. For example, the parameter pattern may comprise a set of acceleration measurement values which occur upon the mobile device 19 being arranged in the predefined inclined orientation and/or a set of light intensity measurement values which occur upon the mobile device 19 being held in the support structure 17, possibly with its light sensor 23 being covered by the cover shield element 25. Furthermore, as part of the parameter pattern, it may be checked whether such measurement values are static, i.e. do not significantly change, during a predetermined time interval of for example 5 s.

If a correspondence between the actually measured measurement values and the parameter pattern occurs, it is assumed that the mobile device 19 is correctly coupled with the holder structure 17. Thereby, starting of a specific measurement acquisition procedure is automatically triggered.

During such measurement acquisition procedure, measurement values are sensed by at least one of the sensors 20 of the mobile device 19, preferably repeatedly or even continuously. For example, accelerations acting onto the mobile device 19 may be measured using the 3D acceleration sensor of the mobile device 19. Noises occurring in the environment of the mobile device 19 may be measured using the microphone of the mobile device 19. Magnetic, electric or electromagnetic fields occurring in the environment of the mobile device 19 may be measured using corresponding field sensors of the mobile device 19. Similarly, temperatures, humidity and/or other physical parameters may be measured by sensors 20 of the mobile device 19. In specific cases, even a current location of the mobile device 19 may be measured using for example a GPS sensor of the mobile device 19.

The sensed measurement values may be directly transmitted to an evaluation unit 37 (FIG. 1) arranged for example in a remote control center for further evaluation. Alternatively, the sensed measurement values may be temporarily stored in the mobile device 19 and may be transmitted to the evaluation unit 37 at a later point in time. Optionally, the sensed measurement values may be already pre-processed or pre-evaluated within the mobile device 19. Transmission of the measurement values or of any pre-processed or pre-evaluated values to the evaluation unit 37 may be performed preferably by a wireless data transmission using for example data transmission capabilities of the mobile device 19. For example, data may be transmitted via the internet.

As soon as the mobile device 19 is removed from the holder structure 17, this may be remarked by the mobile device 19 as for example the actually measured measurement values do no more correspond to the predefined measurement pattern. The measurement acquisition procedure may then be automatically stopped.

According to an alternative implementation of the method proposed herein, the mobile device 19 also continuously checks whether it is in the predefined position and/or the predefined orientation. However, in this case, the predefined position/orientation do not necessarily result from the mobile device 19 being directly mechanically coupled to the holder structure 17. Instead, the elevator car 3 may be provided with specific facilities, such as for example a graspable handle, which motivate a passenger to position and/or orient its mobile device 19 in a predefined manner, possibly within acceptable tolerances. For example, a passenger may carry a wearable device at or on one of his body parts and the facility provided in the car 3 may motivate the passenger to arrange the respective body part at a specific location and/or orientation within the elevator car 3. For example, the passenger may carry a smartwatch on his wrist and a handlebar or another physical apparatus may be provided in the elevator car 3 which induces the passenger to position his wrist with the smartwatch in a distinct position/orientation. For example, a waist-level handlebar may induce passengers to grab onto it, thereby fixing their wearable smartwatch to be in a distinct position perpendicular to the horizontal handlebar. In a specific implementation, a graspable handle may be provided in the elevator car 3 that requires the passenger to grasp from the underside such that, consequently, a watch face on the grasping hand would be facing downwards, resulting in an extended unique accelerometer signal due to the effect of gravity. The handle could also constrict the passenger's wrist motion during the elevator ride. The specific position and/or orientation of the mobile device 19 may then be detected by the mobile device based on corresponding sensor signals and the measurement acquisition procedure may be started accordingly.

In order to motivate elevator passengers to offer their personal smart mobile devices 19 for monitoring the elevator operation and couple the mobile device 19 to the holder structure 17, i.e. to incentivize passengers to participate in temporarily re-purposing of their mobile devices 19, some motivation measures may be implemented. For example, some gamification or mobile-related services may be considered.

For example, pay-for-lift schemes where passengers pay for their rides via identifiers on their mobile devices 19 may be considered. In such case, the elevator 1 only registers via the identifier when the mobile device 19 is placed within the holder structure 17.

Alternatively or additionally, badging of time in and out of a building or floor by placing the mobile device 19 in the holder structure 17 may be considered.

As another option, the mobile device 19 may be used for unlocking floors upon being coupled with the holder structure 17.

A further alternative could be games where riding different elevators helps a player to collect virtual “badges” and a way to collect badges is to couple the mobile device 19 with the holder structure 17.

As another motivation measure, specific services may be installed and/or enabled on the passenger's mobile device 19 upon being coupled with the holder structure 17. For example, a specific “selfie app” could be installed on a smart mobile device 19 such that photos or videos are taken when the passenger is in the elevator car 3. Such photos or videos may then be given to the owner of the mobile device 19. Accordingly, upon the mobile device 19 being coupled to the holder structure 17, not only the measurement acquisition procedure is automatically started and ride quality data representing the operation of the elevator 1 are collected, but, in parallel, a camera is activated for taking photos or videos of the passengers. The camera may be the camera of the mobile device 19 or another camera fixedly installed within the elevator car 3. Offering photos or videos to elevator passengers may be specifically attractive and therefore may be a good motivation measure for example in cases of a panorama elevator. The photos or videos may show the passenger for example with an imposing background. Furthermore, such photos or videos may be attractive for example for elevators to a nightclub or restaurant or for elevator enthusiasts. In particular, passengers may be motivated to putting the photos or videos on a website or use them for a game (for example “who can get the most elevators selfies”).

Optionally, for example a QR code or a beacon or other identification means may be provided in or near the elevator car 3 in order to enable the passenger to download a correct software application and/or identify the location.

With embodiments of the elevator 1 and the method for monitoring an operation of the elevator 1 proposed herein, several advantages may be realized.

For example, prior approaches such as the approach described in EP 16188445 use a passenger movement-based solution for triggering a mobile device for sensing during the passenger's ride. However, such approaches may be unreliable due to false positives that occur during daily life. With the approach described herein, triggering of the mobile device 19 to execute the measurement acquisition procedure may be more reliable.

Furthermore, measurement values which are sensed by the mobile device's sensors may be more accurate and reliable due to the direct mechanical coupling to the elevator car 3 via the holder structure 17.

Additionally, the fixed position and orientation of the mobile device 19 being coupled to the holder structure 17 may enable a direct comparison of sensor signals between measurements from different mobile devices 19 and/or different time frames.

Furthermore, arranging the holder structure 17 with its coupled mobile device 19 in proximity to panels of an elevator car door 35 may enable sensing of door movements through a magnetometer sensor of the mobile device 19.

Finally, it should be noted that the term “comprising” does not exclude other elements or steps and the “a” or “an” does not exclude a plurality. Also, elements described in association with different embodiments may be combined.

In accordance with the provisions of the patent statutes, the present invention has been described in what is considered to represent its preferred embodiment. However, it should be noted that the invention can be practiced otherwise than as specifically illustrated and described without departing from its spirit or scope.

1-12. (canceled)

13. An elevator including a displaceable elevator car and a holder structure fixed to the elevator car for holding a smart mobile device of a passenger in the elevator car, the holder structure comprising:
the holder structure being configured to releasably mechanically couple the mobile device to the elevator car; and
at least one of—
the holder structure being configured to hold the mobile device such that acceleration sensors of the mobile device sense an acceleration pattern resulting upon the mobile device being held by the holder structure; and
a light sensor of the mobile device senses a light pattern resulting upon the mobile device being held by the holder structure.

14. The elevator according to claim 13 wherein the holder structure is configured for holding the mobile device in a positive fit connection.

15. The elevator according to claim 13 wherein the holder structure is configured for holding the mobile device in a predefined inclined orientation relative to a horizontal plane.

16. The elevator according to claim 13 wherein the holder structure is fixedly attached to one of a wall of the elevator car and an elevator car carrier structure carrying the elevator car.

17. The elevator according to claim 13 wherein the holder structure is fixedly attached to the elevator car at a position neighboring an elevator car door displacement path along which an elevator car door of the elevator car is displaceable upon being opened and closed.

18. The elevator according to claim 13 including motivation measures for motivating the passenger to couple the mobile device with the holder structure during an elevator travel of the elevator car.

19. A method for monitoring an operation of an elevator including an elevator car, the method comprising the steps of:
providing a smart mobile device of a passenger in the elevator car with application software controlling the smart mobile device to execute the following monitoring procedure;
repeatedly supervising measurement values generated by at least one sensor of the smart mobile device;
upon occurring of a specific parameter pattern in the measurement values, starting a measurement acquisition procedure during which measurement values are sensed by the at least one sensor and the sensed measurement values are transmitted to an evaluation unit for further evaluation; and
wherein the specific parameter pattern results upon the smart mobile device being held in at least one of a predefined position and a predefined orientation in the elevator car.

20. The method according to claim 19 wherein the monitoring procedure includes:
continuously supervising acceleration measurement values generated by acceleration sensors of the smart mobile device; and
upon occurring of a specific acceleration pattern in the acceleration measurement values, starting the measurement acquisition procedure.

21. The method according to claim 19 wherein the monitoring procedure includes:
continuously supervising light measurement values generated by a light sensor of the smart mobile device; and
upon occurring of a specific light pattern in the light measurement values, starting the measurement acquisition procedure.

22. The method according to claim 19 wherein the monitoring procedure includes:
continuously supervising the measurement values; and
upon occurring of the specific parameter pattern in the measurement values for more than a predetermined time interval, starting the measurement acquisition procedure.

23. A computer program product comprising non-transitory computer readable instructions which, when performed by a processor of a smart mobile device, instruct the smart mobile device to execute the following monitoring procedure:
continuously supervising measurement values generated by at least one sensor of the smart mobile device;
upon occurring of a specific parameter pattern in the measurement values, starting a measurement acquisition procedure during which measurement values are sensed by the smart mobile device and the sensed measurement values are transmitted to an evaluation unit for further evaluation; and
wherein the specific parameter pattern results upon the mobile device being held by a holder structure configured to releasably mechanically couple the smart mobile device to an elevator car.

24. A non-transitory computer readable medium comprising the computer program product according claim 23 stored thereon.
